(19) United States
(12) Patent Application Publication
(10) Pub. No.: US 2010/0262551 A1
(43) Pub. Date: Oct. 14, 2010

(54) METHOD AND APPARATUS FOR DIGITAL COATING PROJECT PURCHASE

(75) Inventors: Christopher Caruso, Pittsburgh, PA (US); Jeffrey Lipniskis, Sarver, PA (US); Mathew A. Ficco, McDonald, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/758,840

(22) Filed: Apr. 13, 2010

Related U.S. Application Data
(60) Provisional application No. 61/169,072, filed on Apr. 14, 2009.
(60) Provisional application No. 61/295,872, filed on Jan. 18, 2010.

(51) Int. Cl. G06Q 30/00; G06Q 99/00; G06Q 50/00; G05D 11/13; G06F 17/30

(52) U.S. Cl. 705/319; 705/1.1; 705/347; 700/265; 707/780; 707/722; 707/E17.014

(57) ABSTRACT

A method for selecting and purchasing a coating includes: selecting a desired color, comparing the desired color to a database of coating compositions to identify a coating composition having a color substantially matching the desired color, evaluating the suitability of the identified coating composition, and purchasing the identified coating composition. An apparatus for implementing the method is also provided.

### CROSS-REFERENCE TO A RELATED APPLICATION

This application claims the benefit of U.S. Provisional Patent Application Ser. No. 61/169,072, filed Apr. 14, 2009 and titled “Method of Selecting a Coating Composition Matching Articles in a Color Photograph” and U.S. Provisional Patent Application Ser. No. 61/295,872, filed Jan. 18, 2010 and titled “Paint Purchase Process”, both of which are hereby incorporated by reference.

### FIELD OF THE INVENTION

The present invention relates to a method and system for selecting and purchasing coating compositions such as paints, stains or other coatings.

### BACKGROUND OF THE INVENTION

Architectural coatings, including indoor and outdoor paints, stains and industrial coatings, are commonly provided in a large variety of colors. Paint color display systems are used to display various paint color samples to assist consumers in selecting paint colors. These systems typically involve the use of a display board, pamphlet, book, or multi-tiered display with ink-based or paint color samples. A difficulty arises in selecting a paint color to match or coordinate with the paint colors in an indoor environment, such as a room. The color samples are typically produced on a paper substrate that are on the order of the size of a business card and are taken into the room to be painted and compared to the furnishings therein. The small paint color samples are difficult to compare to all of the colors that are present in a room because the samples are relatively small in relation to the structure in the room or the part of the structure that will be painted. It is difficult to obtain an accurate impression of the finished environment with the selected color. The user tries to imagine how the room will appear when painted with the color of the small sample, but this is difficult to do.

A need remains for a system for selecting a color coating composition that matches or is coordinated with the structure, part of a structure, or other component of a preexisting environment.

### SUMMARY OF THE INVENTION

In a first aspect, the invention provides a method including: selecting a desired color, comparing the desired color to a database of coating compositions to identify a coating composition having a color substantially matching the desired color, evaluating the suitability of the identified coating composition, and purchasing the identified coating composition.

In another aspect, the invention provides an apparatus including a user interface, and a processor configured to communicate with the user interface and programmed to compare a desired color to a database of coating compositions to identify a coating composition having a color substantially matching the desired color, and to enable a user to evaluate the suitability of the identified coating composition.

In another aspect, the invention provides a non-transitory computer readable medium including software for causing a processor to compare a desired color to a database of coating compositions to identify a coating composition having a color substantially matching the desired color, and for enabling an evaluation of the suitability of the identified coating composition by a user.

### BRIEF DESCRIPTION OF THE DRAWINGS

FIG. 1 is a flow chart of a process for selecting a paint color.

FIGS. 2A and 2B together are a flow chart of another process for selecting a paint color.

FIGS. 3A and 3B together are a flow chart of another process for selecting a paint color.

FIG. 4 is a block diagram of a computer system that can be used for selecting a paint color and purchasing paint.

FIG. 5 is a block diagram illustrating a paint purchase process.

### DETAILED DESCRIPTION OF THE INVENTION

In various aspects, the invention provides a method and apparatus for selecting a paint color and purchasing paint. In one aspect, the invention provides a method and apparatus for a user to identify a paint color for painting a room. However, the invention may be used with other environments including exterior environments. While the following description frequently refers to paint, it should be understood that the method and apparatus apply to the selection and purchase of other types of coatings, including stain and industrial coatings.

The described embodiments of the invention should not be considered as limiting. A method consistent with the present invention may be practiced in a variety of fields such as the matching and/or coordination of apparel and fashion products.

The method of the invention is suited for use with a computer system that may be a stand alone unit or include one or more remote terminals in communication with a central computer via the Internet. As such, the computer or “processor” and related components described herein may be a portion of a local computer system or a remote computer or an on-line system or combinations thereof. The database and software described herein may be stored in computer internal memory or in a non-transitory computer readable medium.

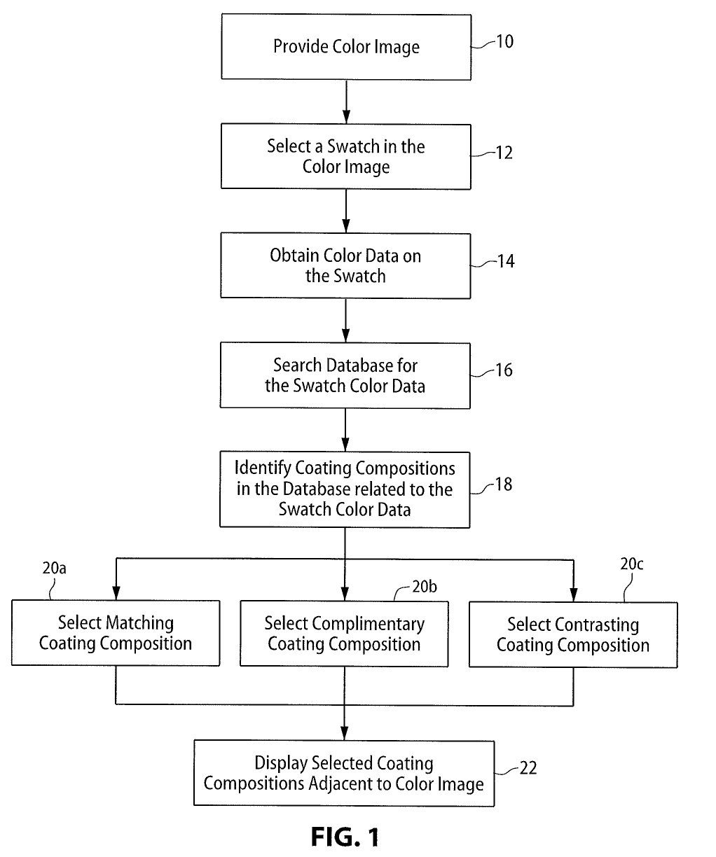

In one embodiment as shown schematically in FIG. 1, a color image having a color which the user intends to match or coordinate therewith is selected in step 10. As used in this description, a color image may be, for example, a photograph, image, drawing, painting, graphic or other object. By a matching color, it is meant that the color in the color image and the color of a coating composition are similar enough so as to be acceptable to a user. In one of the examples, the colors may be indistinguishable by the human eye. Alternatively, the colors may be distinguishable, but deemed close enough such that the coating composition would be acceptable for the envisioned use. By coordinating color, it is meant that the color in the color image that complements the color or contrasts with the color of a coating composition, in other words, does not match the color composition but is esthetically pleasing therewith. In step 12, the user selects a swatch in the color image for identifying a coating composition. For example, when the image is a photograph of a room with its contents, the swatch may be the color of the walls, carpeting, piece of furniture, or the like.

In step 14, color data on the swatch is obtained. Color data of a color swatch may be obtained by displaying the image and positioning a cursor over a desired portion of the image and clicking a mouse to select that portion of the image. The computer may be programmed to measure the color properties of the swatch. For example, in measuring the color of a swatch, color data is often determined by reflectance data in a color space such as the CIE 1976 (L*c*h*) color space that is based on tristimulus values of colors using the three primary colors (red, yellow and blue). The L*c*h* values represent brightness, chroma, and hue, respectively. The color data for the color swatch of the color image may be determined using a spectrophotometer that provides a measurement of the color data of the swatch. Alternatively, if the color swatch is a portion of a digital photograph or other digital image, the color data may be extracted therefrom. For digital color swatches, the color data may be extracted by previously known software on a computer that extracts color from a digital photograph.

The color data for the swatch is entered into a computer having a database and software for conducting a search of the database. The color data may be transferred to the computer via numerous means such as wireless communication, memory sticks or other computer readable media, via a remote server, or the Internet. By “computer”, it is meant any microprocessor based device, such as a desktop computer, laptop computer, computer network, a remote server, or a handheld device, such as a cellular device or personal data assistant (PDA). The method may be performed on a single computer or a network of computers. For example, a user may provide the color image and select a swatch thereof on a first computer or terminal and the color data then is transferred to a second computer having the database and search software. The first computer may be located in the user's home or may be a terminal with input device and displaying device that is located in an in-store paint selection kiosk or the like. The second computer may be a central computer for conducting multiple searches by many users or may be located in a paint store.

In step 16, software on the computer searches the computer database for the color data relating to the swatch using the software. The database may include a listing of coating compositions associated with matching color data, complementary color data, and contrasting color data. The software searches the computer database for matching color data, complementary color data, and/or contrasting color data that relate to the swatch color data. Alternatively, once a matching color is identified, complementary color data, and/or contrasting color data may be determined using an algorithm that is known in the art. Matching color data is color data that when converted to a color, matches the swatch color. Complementary color data and contrasting color data are color data that, when converted to a color, are complementary or contrasting to the swatch color, respectively. The result of the search is an identification of a coating composition having color data related to the swatch color data and may include an indicator that the color of the identified coating composition matches, complements, or contrasts with the color of the swatch. The search for matching color data in the database that relates to the swatch color data may be narrowed, e.g., to only one of matching color data or complementary data or contrast color data. The user may select one or more of a matching coating composition (step 20a), a complementary coating composition (step 20b), or a contrasting coating composition (step 20c). In one embodiment, the formulation for the identified composition is provided to a dispensing system. In another embodiment, the color information may be sent to a user station or kiosk via a network or other communications link. In another embodiment, the color information can be sent to a tinting station where one or more tints can be added to a base to produce a coating having the matching color. In addition, the identified coating composition may be displayed on the screen of the user's computer in step 22 adjacent the color image or the color swatch. In this manner, the user can assess the acceptability of the identified coating composition with the desired environment.

In another embodiment of the invention, a visualization component could be provided. The visualization component may include a digital photograph that is displayed on a computer screen and is colorizable with the color of the identified coating composition. The software on the computer allows a user to click on a portion of the image and colorize that portion with the color of the identified coating composition. Upon selection of a coating composition as described above, the color image is altered to exhibit a portion of the image as it would appear if painted with the identified coating composition. The user can select alternate coating compositions, such as coating compositions with complementary or contrasting colors or perform a different search by selecting a different swatch to obtain a different set of matching, complementary or contrasting coating compositions. Accordingly, the user can try various color schemes in the environment on screen.

In yet another embodiment, the color image colorized with the identified coating composition is displayed at a plurality of light levels or from a plurality of viewing angles or both. The software for displaying the image allows the user to adjust the apparent light levels (to simulate daylight or artificial light) and to view the environment at multiple angles as is known in the art.

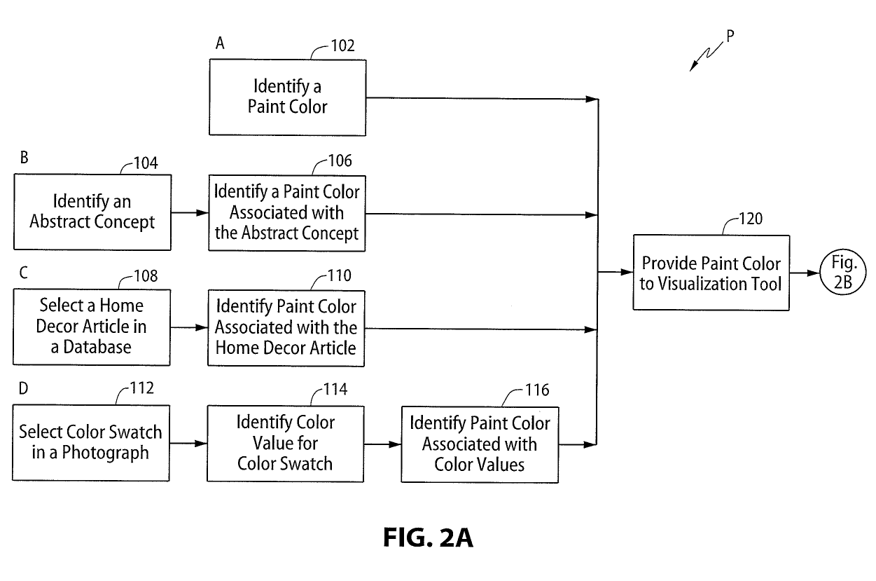

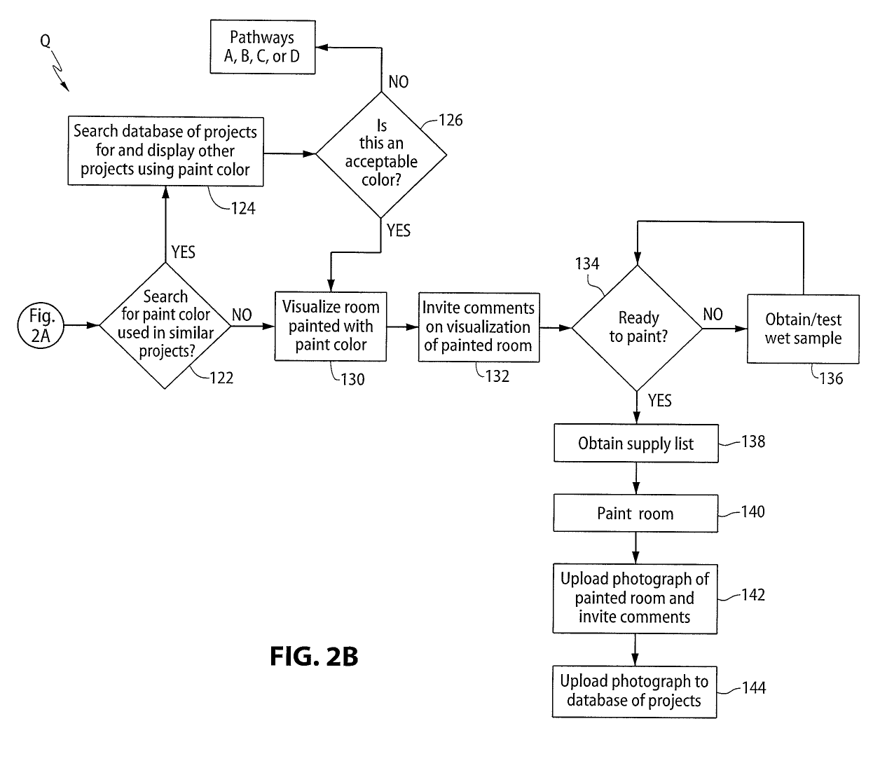

Another embodiment includes a method of visualizing a color in an environment which provides the user with input on color selection by others. For some people, choosing color to decorate a room or other environment is difficult. With the myriad of paint colors to choose from, additional confirmation on their choice of color may be helpful. By way of a non-limiting example, the method is described in reference to visualizing the color of a room painted with a selected paint color. Referring to FIGS. 2A and 2B, a user seeking to visualize color in a room identifies a desired paint color in subsystem P (FIG. 2A) using pathway A, B, C, or D and visualizes that paint color with input from others (e.g., input received from a social network website) in a visualization subsystem Q (FIG. 2B). The pathways A-D, shown in FIG. 2A, for identifying a paint color are not meant to be limiting. In pathway A, the user knows the identity of a paint color (e.g., “Desert Shale”) and preselects that color in step 102. Alternatively, the user may identify a paint color by proceeding through steps 104 and 106 of pathway B and utilize a system such as the Color Sense Game, an on-line tool available from PPG Industries, Inc. In step 104, the user identifies an abstract concept, such as a feeling or mood, to associate with a color. For example, the user may identify “subdued” in step 104. The tool identifies a paint color (or more than one paint color) in step 106 that is associated with that concept. The user enters “subdued” into a computer system via a remote terminal and a search is conducted on-line for the paint color(s) associated therewith. Output from the search includes the paint color name (e.g., “Desert Shale”) and, optionally, an on-screen color swatch thereof. If more than one paint color is identified, the user may select one of those before proceeding. Alternatively, using pathway C, the user may follow steps 108 and 110 using a preexisting database of colored articles. The user selects a home decor object in a user supplied photo or in a database of home decor products in step 108. The database includes paint colors associated with the products. In step 110, the paint color associated with the product selected by the user in step 108 is identified. One system for practicing pathway C is described in U.S. Pat. No. 6,928,454 to Menner et al., incorporated herein by reference in its entirety. The database may include the identity of home decor items that have been certified as being color compatible with each other or with particular paint colors.

In pathway D, the user may follow steps 112 to 116 to identify a color associated with home decor. In step 112, the user selects a colored swatch from an image, such as a digital photograph of a room displayed on a computer system. For example, the user selects the color of fabric on an upholstered chair in a digital photograph, video, or other image displayed on a computer screen. The software on the computer provides the user with a tool for selecting (pointing to) the color in step 112 and converting the color thereof to color data, as described above. The color data of the selected color serves as a basis for searching a database of paint colors associated with color data. The database is searched for the color data of the selected color and the computer identifies a paint color associated therewith at step 116. The end point of pathway A, B, C, and D is the identification of a paint color at step 120. In the example described herein, the user has selected a particular paint color (e.g., “Desert Shale”) either by preselecting the color in pathway A, identifying the paint color according to a concept about the color in pathway B, selecting the color that matches an article of home decor in pathway C, or selecting a color swatch and identifying a paint color associated therewith in pathway D.

The paint color selected by pathway A, B, C, or D is visualized and managed by the user via a color visualization tool of system Q. The user has an option at choice step 122 to visualize the selected paint color in a scene that may be retrieved from a database of sample rooms, which may include a room of another user, to provide an indication of how the paint color appears when used. If this option is chosen, in step 124, a search is conducted of a computer database of other rooms painted with the selected color for viewing by the user. The other “painted rooms” viewed by the user may be digital photographs of actual rooms painted with the paint color by other users of system Q, digital photographs that have been “virtually” painted (colorized with the paint color by other users), or stock images of rooms actually painted or virtually painted with the paint color. This step 124 allows the user to view rooms painted the same color as the user has selected and helps the user confirm that the selected color is acceptable at choice step 126. If the identified paint color is not acceptable, the user can select another paint color and return to subsystem P. If the identified paint color is acceptable, the paint color is used in step 130 to visualize the user's room painted with the selected paint color. It should be appreciated that step 130 may be practiced directly following step 122 without viewing other rooms painted with the selected paint color. In step 130, a digital photograph of a room is colorized with the selected paint color. The digital photograph includes an image of the user's room to be painted or may be a stock photograph on which the user wants to test the paint color. The database of the system Q may maintain a plurality of stock photographs for colorization with paint colors selected by users thereof. The user may also upload a photograph for colorization with the selected color.

In step 132, the user has the option to post the colorized photograph to an on-line site or blog and invites others to access the blog and comment on the paint color. This can be implemented by providing a link to a social network (e.g., Facebook or Twitter) on the display being used by the user. Clicking on the link will connect the user to the social network cite where the colorized photograph can be posted and comments or other input can be solicited. Based on the input, the user decides at choice step 134 whether to obtain wet (actual) samples of the paint to test on the actual room (step 136). If the user is satisfied with the paint color, in step 138, a supply document (shopping list) can be prepared. The supply document may include the paint color name and formulations for various sheens (semi-gloss, satin, flat, etc.), store location for purchasing the paint, and a coupon for paint bought at the store. Step 138 may also generate a project number that is unique to the user's project for further retrieval. The user may bring the project number to a paint store, where the user may enter the project number in a lookup database accessed from a store computer to identify the supplies needed for painting. In step 140, the room is painted, and the user digitally photographs the painted room in step 142. The photograph of the room can be uploaded to a blog or other social network as a finished project in step 144 on which other users may comment. In addition, the photograph may be added to the database of projects in subsystem Q for use in a subsequent application of the method.

In this manner, users of the system continuously build content to subsystem Q as both finished projects painted with paint colors selected using the system and comments thereon. For rooms that are all painted the same color, a future user may view how a particular color appears in various environments. The database of finished projects may include data relating to the popularity of a color, such as the number of times a particular color has been used or selected in previous projects, and/or data indicating which colors have been used most frequently in a particular time period.

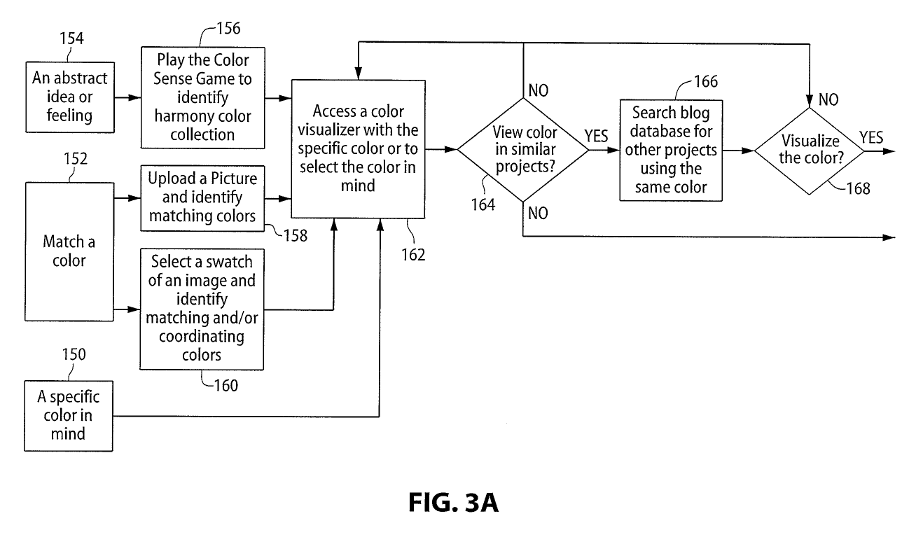

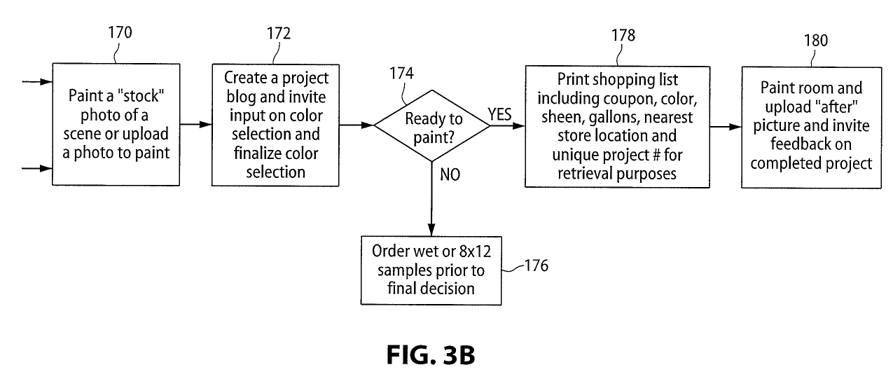

FIGS. 3A and 3B illustrate another embodiment of the present invention. FIG. 3A illustrates three entry points to the process. In step 150, a user has a specific color in mind. In step 152, the user desires to match a color in, for example, an image. In step 154, a user has an abstract idea or feeling and wishes to select a color that conforms to the idea or feeling. Where the user has an abstract idea or feeling, the user can access a color selection tool, such as the Color Sense Game as shown step 156. The Color Sense Game can be used as described above with respect to FIG. 2A.

Where a user wishes to match a color, the user can upload an image, as shown in step 158. Alternatively, the user can retrieve other images or visual items, for example from the Internet, or the user can access a database of home decor items as shown in step 160. Once an image is shown on a user display, the user can access a tool that identifies the colors in the image and determines a matching color in a database. For example, a user may move a cursor over a scene in the display and the tool may identify a matching color to a color in the scene at the location of the cursor. The matching color can be displayed in a pop-up window, along with an array of complementary or contrasting colors. The complementary or contrasting colors can be determined using an algorithm for choosing such colors or using a database of such colors.

Once a color is identified, based on for example preselection, matching or abstract concepts, a user can access a color visualizer as shown in step 162. The user then has the option of viewing the color in other similar projects as shown in step 164. If this option is selected, a search of other projects that use the same color can be made as shown in step 166. For example, if the color has been used to paint walls in a kitchen, the visualizer may contain pictures of the kitchen.

If the user does not decide to look for a similar project, the color can still be visualized as shown in step 168. In one such visualization, the color can be used to paint a stock photo of a sample room or the user can upload a photo and apply the color to the uploaded photo as shown in step 170. The visualization can also be performed as described above with respect to FIG. 2B. Once the stock photo or user photo has been modified with the identified color, the user can solicit comments on the modified photo, for example, by posting the photo to a social networking site or creating a blog for others to comment on the photo, as shown in step 172. The system can facilitate the solicitation of comments, for example, by providing a direct link to one or more social networking sites on the user display.

After comments have been received, the user decides if the color is ready to paint as shown in step 174. If not, the system can order a wet paint sample or large color chips that can be used to assist in making a final decision, as shown in step 176. If so, the system can print a shopping list that may include a coupon, color sheen, number of gallons, nearest store location, and a unique project number that can be used for retrieving information related to the selection process and/or the final color choice, as shown in step 178. Then the paint can be applied to the room and a picture of the painted room can be uploaded to solicit feedback on the completed project, as shown in step 180.

The various steps and decisions illustrated in FIGS. 3A and 3B are provided as a possible implementation and are not meant to be limiting.

It should be appreciated that the methods described in relation to FIGS. 1, 2A, 2B, 3A and 3B can be performed on computer systems or networks. The computer components include databases for storing digital images, software for all tasks described herein, such as colorizing images, converting color data to color and vice versa, accepting and posting comments by users to a blog, adding digital images to the database, and the like as are conventional in the art.

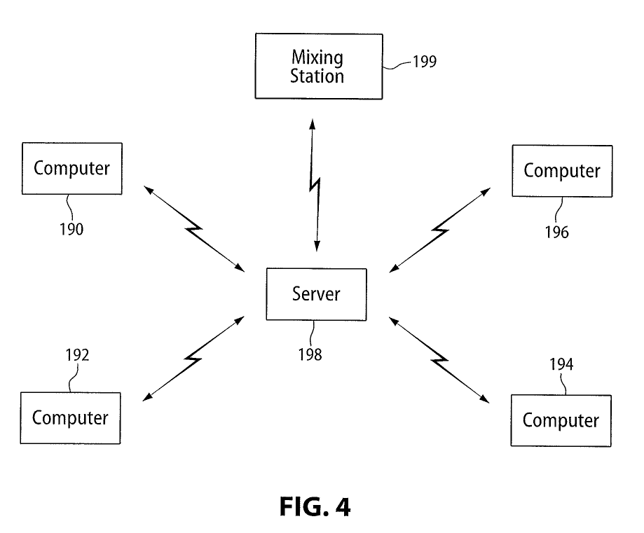

The process described above can be implemented on a single computer or a computer system that includes multiple components that are typically found in a computer network. FIG. 4 is a block diagram of a system that can be used to practice one or more aspects of the invention. The system of FIG. 4 includes plurality of other computers 190, 192, 194 and 196 that may also be connected to a server 198. The computers can be connected to the server, for example, using a wired or wireless connection. Access to the server can be provided over the Internet. The computers can be, for example, user's personal computers or computers located in stores, kiosks or design centers. Such computers include a user interface that may include an input device, such as a keyboard, mouse, touch screen, multi-touch screen, etc. and a display. The user can access a computer via the input device, and can view results on the display. In one embodiment, that display can be a multi-touch display and the computer can be programmed to allow a user to manipulate items on the screen using multi-touch technology.

After a coating color has been identified, color information for that coating can be sent to a dispensing or mixing apparatus 199. In the mixing apparatus, one or more tints can be added to a base to produce a coating having the desired color. In other implementations, a unique identifier for the project, and/or the color composition information can be sent to a cell phone or in-store kiosk so that it will be available at a point of purchase.

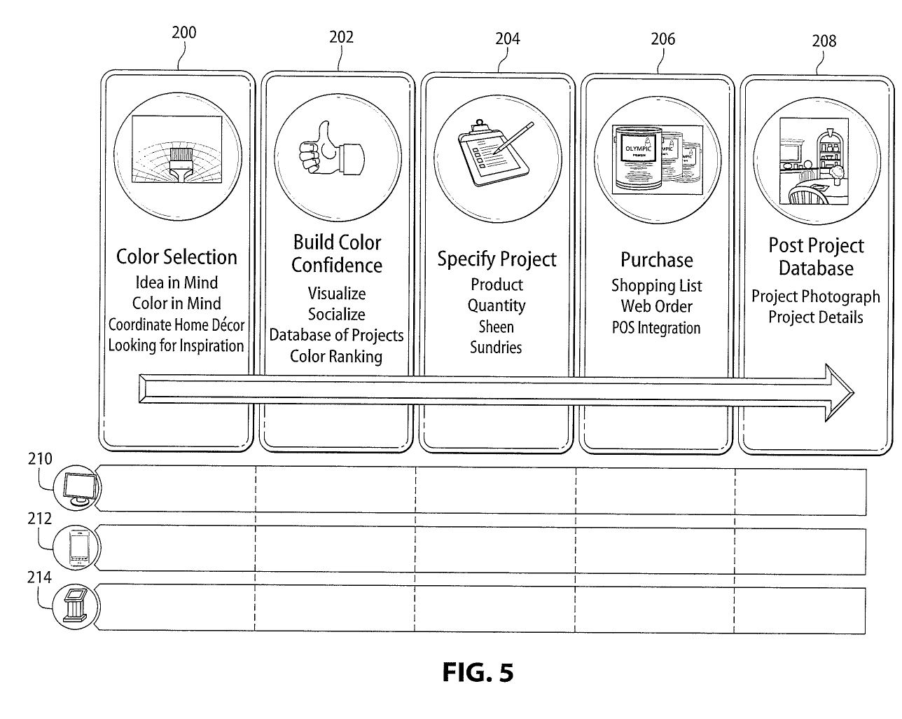

FIG. 5 is a block diagram illustrating a paint purchase process in accordance with an aspect of the invention. The process illustrated in FIG. 5 includes five steps labeled 200, 202, 204, 206 and 208. Color selection step 200 enables a user to find a candidate color that may be suitable for use in the envisioned project. Four starting points are illustrated. In one starting point, the user wishes to find a color that creates a particular mood. In this case, the user might use the color sense game described above to find a color. Alternatively, the user might have a particular color in mind that can serve as a starting color. In another case, the user might wish to find a color that would coordinate with a home decor item. In this case, the user might use a computer tool to identify colors in a photograph or other image of a home decor item as described above with respect to FIGS. 2A and 3A. Another starting point is where the user is looking for inspiration. In this case, the user might use a computer tool to identify colors in a photograph or other image that is not directly related to home decor, such as a photograph of a building or landscape.

In step 202, the user builds confidence in the selected color. This step includes several optional possibilities. In one option, the user visualizes the use of the color. This can be accomplished as described above by colorizing a portion of a photograph or other image with the candidate color. In another option, the user can solicit comments from others using a social network, such as Facebook or Twitter. For example, a colorized image can be posted on a social networking website for comment. The confidence building step may also include a color ranking feature. This feature might provide an indication of the popularity of the candidate color. For example, as multiple users use the process illustrated in FIG. 5, their decisions can be captured in a database. Then the database can be used to determine, for example, the number of times other users have selected the candidate color for use in a particular type of room, such as a kitchen or bedroom. That number can then be used to rank the candidate color with respect to other colors chosen for the particular type of room. The other user color selections need not be the final color chosen, but could be captured at other points in the process. For example, candidate colors that were considered by other users might be captured for the database. In addition, the database might also include colors that complement or contrast with colors considered or selected by other users. It is also possible that step 202 might result in the rejection of the candidate color, in which case, the user would return to step 200 to obtain another candidate color.

The color ranking can be implemented using an algorithm that accesses candidate colors using various data parameters such as: the number of gallons of a particular color sold; the number of times a particular color has been visualized using the selection system; whether the color has been included in a color collection, such as designer recommended colors or colors meeting a color trend factor; colors appearing in photographs or videos that have been uploaded to the system; and/or optional user rankings of colors. These parameters can be weighted such that the factors have a larger or smaller influence on the color ranking. For example, gallons sold may receive a higher weight since that data represents final decisions by previous users.

Once a color has been selected, the project details would be specified as shown in step 204. In this step, the user would enter information about the location in which the paint will be used. For example, the user might select a room type from a list of options, a display of icons, or a pull-down menu on a display screen. The user might further enter dimensions of a location to be painted. Then the system can calculate the quantity of paint that will be required. The user can further specify the paint sheen, and may specify a particular product in a line of paints or other coatings. To make the selection of sheen or product, the user might be presented with a display of samples of the selected color with different possible sheens and/or a display of the selected color in different product lines, and the user might select the desired sheen and/or product by clicking on the display.

After step 204, the system can facilitate the preparation and purchase of the paint as shown in step 206. For example, data from step 204 can be automatically transmitted to a store where the paint color can be prepared. If step 206 is preformed, for example, at a store kiosk, the data might be transmitted directly to a mixing station for preparation of the paint color. Then the data could be sent directly to a cash register, where the user can pay for and pick-up the paint. In another example, the data from step 206 might be used to produce a shopping list. In another example, the data can be used to purchase the paint on-line for future pick-up or delivery.

Information about the finished project can be loaded into a post project database as shown in step 208. This information can include project photographs and other project details. Such project data can then be used by others in step 202.

The steps in FIG. 5 can be performed using a plurality of processing devices. For example, a computer 210 that might be located at a user's home could have software that performs the process steps, or the computer could access a network or server that would contain the necessary software. Alternatively, a mobile device 212 such as a phone, PDA, or other portable device, could be used to access a network or server that contains the necessary software to perform the steps of the process. In addition, the user might use a kiosk that can perform the process using software stored on the kiosk, or by accessing a network. If the kiosk is located at a store, it might send data to a mixing desk and cash register, so that the user can simply pay for and pick-up the paint at the cash register.

In another aspect, the invention can be implemented as a non-transitory computer readable medium containing software for causing a computer or computer system to perform the method described above. More specifically, in one embodiment the invention encompasses a non-transitory computer readable medium including software operable in conjunction with a processor and associated display device for presenting a user with a color image, responding to user input to select a swatch in the color image for relating to a coating composition, obtaining color data for the swatch, searching for the swatch color data in a computer database of coating compositions related to color data, and identifying a coating composition related to the swatch color data. In addition, the software can further implement the other process steps described above, and can provide appropriate links to allow for easy access to social networking sites to solicit comments on results of the visualization steps and the final painted scene. In one embodiment, the invention provides a non-transitory computer readable medium, including software for causing a processor to compare a desired color to a database of coating compositions to identify a coating composition having a color substantially matching the desired color, and for enabling an evaluation of the suitability of the identified coating composition by a user. The software can include various modules that are used to enable a processor and user interface to perform the functions described herein.

It will be readily appreciated by those skilled in the art that modifications may be made to the invention without departing from the concepts disclosed in the forgoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

What is claimed is:

1. A method comprising:
selecting a desired color;
comparing the desired color to a database of coating compositions to identify a coating composition having a color substantially matching the desired color;
evaluating the suitability of the identified coating composition; and
purchasing the identified coating composition.

2. The method of claim 1, wherein the evaluating step comprises one or more of:
visualizing the coating composition;
soliciting comments on the coating composition;
comparing the coating composition with coating compositions used in other projects; and
viewing a color ranking for the coating composition.

3. The method of claim 2, wherein the step of visualizing the coating composition comprises:
displaying an image including the coating composition color.

4. The method of claim 2, wherein the step of soliciting comments comprises:
sending information about the coating composition to a social networking site and receiving comments from others.

5. The method of claim 2, wherein the step of comparing the coating composition with coating compositions used in other projects comprises:
viewing images of other projects that utilized the coating composition.

6. The method of claim 2, wherein the step of viewing a color ranking for the coating composition comprises:
generating a color ranking for the coating composition; and
displaying the generated color ranking.

7. The method of claim 6, wherein the step of generating a color ranking for the coating composition comprises:
weighting a plurality of parameters related to the coating composition; and
generating the color ranking based on the weighted parameters.

8. The method of claim 1, further comprising, prior to the purchasing step:
specifying project details.

9. The method of claim 1, further comprising, prior to the purchasing step:
using the identified coating composition to determine one or more tint components for a coating; and
mixing the tint components with a base to produce a coating having a color substantially matching the desired color.

10. The method of claim 1, wherein the step of selecting a desired color comprises:
identifying a color swatch in an image; and
obtaining color data for the swatch.

11. The method of claim 1, further comprising, prior to the purchasing step:
generating a list of supplies for using the coating composition in a project.

12. An apparatus comprising:
a user interface; and
a processor configured to communication with the user interface and programmed to compare a desired color to a database of coating compositions to identify a coating composition having a color substantially matching the desired color, and to enable a user to evaluate the suitability of the identified coating composition.

13. The apparatus of claim 12, wherein the user interface comprises:
a display for visualizing the coating composition, comparing the coating composition with coating compositions used in other projects, and/or viewing a color ranking for the coating composition.

14. The apparatus of claim 13, wherein the display shows an image including the coating composition color.

15. The apparatus of claim 13, wherein the display shows images of other projects that utilized the coating composition.

16. The apparatus of claim 13, wherein the processor generates the color ranking for the coating composition.

17. The apparatus of claim 16, wherein the processor generates the color ranking by weighting a plurality of parameters related to the coating composition; and generating the color ranking based on the weighted parameters.

18. The apparatus of claim 12, further comprising:
an interface to a social networking site for soliciting comments on the coating composition.

19. The apparatus of claim 12, further comprising:
a mixer for mixing one or more tint components with a base to produce the coating composition having a color substantially matching the desired color.

20. An apparatus comprising:
a non-transitory computer readable medium including software for causing a processor to compare a desired color to a database of coating compositions to identify a coating composition having a color substantially matching the desired color, and for enabling an evaluation of the suitability of the identified coating composition by a user.
